(19) United States
(12) Patent Application Publication
(10) Pub. No.: US 2005/0050788 A1
(43) Pub. Date: Mar. 10, 2005

(54) Spring loaded tubular fishing pole

(76) Inventor: Shane Patrick Cahill, New York, NY (US)

Correspondence Address: Shane Cahill;Apt. 1, 335 E. 54th St., New York, NY, 10022, US

(21) Appl. No.: 10/645,072

(22) Filed: Aug. 21, 2003

(51) Int. Cl. A01K 91/02

(52) U.S. Cl. 43/19

(57) ABSTRACT

This invention pertains to fishing poles whose bait is cast with the use of a compression spring. A traditional reel is used, but not a traditional rod. The rod is hollow and tubular in shape, and contains a compression spring. The fishing line runs from the lure at the top of the tube, through a funnel shaped container, through the length of the spring, and into the reel. Previous inventions allow their respective bait carriers to exit the rod. In this invention, however, neither the spring nor the funnel shaped container exit the tube due to a spring seat at the bottom of the tube and two small notches at the top. The angler reels in the lure, which enters the funnel shaped container, which engages the spring. The spring is compressed until the moment the angler pushes the reel button, releasing the tension and propelling only the lure out of the tube.

### CROSS-REFERENCE TO RELATED APPLICATIONS

| | | |
|---|---|---|
| 764,853 | July 1904 | Kimberlin |
| 1,124,726 | January 1915 | Gray |
| 1,595,275 | October 1924 | White |
| 2,187,807 | October 1935 | Muckey |
| 2,216,341 | September 1937 | Hagen |
| 2,305,176 | September 1940 | Littman |
| 2,334,646 | December 1942 | Price |
| 2,584,678 | February 1952 | Dewey |
| 2,729,012 | January 1956 | Lee |
| 2,777,239 | January 1957 | Cushman |
| 2,795,884 | June 1957 | Wright |
| 2,817,178 | December 1957 | Keck |
| 3,026,644 | March 1962 | Raider |
| 3,266,184 | August 1966 | Brown |
| 3,416,256 | December 1968 | Blocker |
| 3,727,338 | September 1971 | Pedersen |
| 5,926,991 | October 1999 | Chesnut |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF INVENTION

This invention is an improvement in the field of mechanically cast fishing lines. There have been devices invented which use a variety of methods for launching a fishing lure without the motion of the traditional cast. These include devices with spring mechanisms attached to a standard pole such as Blocker, 1968; manually locked levers that are pulled and released such as Raider, 1962; devices in the form of a gun that propel a lure, and even more powerful devices that use gas and air pressure to launch a lure, the most recent being Harrison, 2002. Others, such as Pedersen, 1973, use a tubular pole that collapses, but here the method by which the pole is cast is the traditional method. Yet another invention, Chesnut, 1999, employs a “line carrier” and washer, which are propelled by a spring and serve to catch the bait as it reaches the tip of the pole, thus causing a loss in momentum. Kimberlin, 1904 uses a similar tubular rod method, but again, the fishing line runs outside of the tube and through eyelets.

Most of these devices are attached to traditional fishing poles, leave the lure exposed throughout the launch, and/or are quite complex to manufacture and use. The invention described below incorporates many of the ideas behind these early models and combines them into a device that is simple to cast, safe for the caster and people nearby, and easy to manufacture.

### BRIEF SUMMARY OF THE INVENTION

This invention is a fishing pole that can cast a lure or bait without the use of a traditional cast. This invention solves the problems of previous inventions in four ways. First of all, it provides the angler with both a lure and casting mechanism that is protected from themselves, fellow anglers, and the elements. Second, the angler is able to compress the spring inside the tubular rod simply by using the force of a standard reel because the spring runs the length of the tube and is of lightweight material, and therefore easily compressed. There are no complex levers or triggers to be set. Third, there is no attachment of a separate device to a standard rod like many prior inventions. Fourth, unlike Chesnut, 1999, nothing additional needs to be propelled with the lure. The moment the “line carrier” engages with the bait there would be a loss in momentum.

While the fishing reel can be any standard push-button (also referred to as spincast) reel, a traditional rod is not used. The fishing rod and the contents within it are the basis for this invention. A standard fishing reel can be attached to this fishing rod via the standard method employed today or by molding the rod and reel into one unit. The rod itself is tubular in shape, with a hollow inner diameter of approximately 1.5 inches for conceptual purposes. From this point, this hollow tubular structure will be referred to as the “rod”. The rod is aligned directly over the reel hole where the string is deployed. The rod contains a spring that runs nearly the entire length of it. At the top of the rod, either resting or connected to the spring, is a funnel with a wide upper portion and narrow lower portion. This funnel allows passage of the fishing line but not of the fishing lure or bait, which will be referred to simply as the lure. The very end of the tube may have two small notches or may become slightly narrower so that neither the spring nor the funnel exit at the end, yet the string and lure pass undeterred. Also, the outer portion of the upper end of the tube is slightly rounded so that the hooks on the lure cannot grab onto it. The lure is reeled into the tube, and then into the funnel. As the string is continually reeled, the lure enters the funnel, the funnel slides toward the reel, and the spring is compressed. Push-button reels are designed to hold the string in the present position until the string is released by the angler, thus releasing tension on the spring and sending only the lure out into the water.

### BRIEF DESCRIPTION OF THE SEVERAL VIEWS OF THE DRAWING

FIG. 1 is a view of the profile of the pole.

FIG. 2 is a cross-sectional frontal view of the pole. In addition, the inner workings of the mechanism are shown.

FIG. 2A is an exploded view of the upper portion of FIG. 2.

FIG. 2B is an exploded view of the lower portion of the tubular rod of FIG. 2.

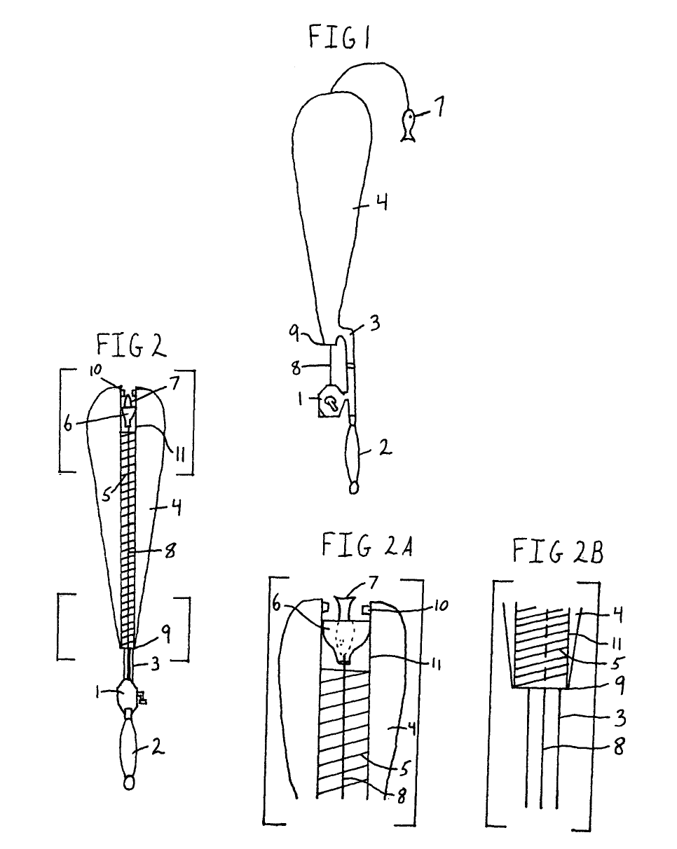

FIG. 1 is a drawing that shows how the invention would appear from the profile to the user. A standard push-button reel 1 is connected to a standard fishing handle 2 by means currently employed today or other means necessary due to the material that the said rod 2 consists of. This handle 2 is attached to a curved connector 3 that connects said handle 2 to the tubular rod 4. The reason why the top of the tubular rod is rounded is simply so that when a lure 7 consisting of one or more hooks exits the water and enters the rod, there is no surface for the hook to grab onto. The rod's outer diameter at the bottom of the tube will likely be less than the upper diameter because of the need for this rounder shape at the top. The bottom of the tubular rod 4 consists of a closing flap 9 at the bottom of the tube that contains a hole in the middle of it that allows the fishing line 8 to pass through it, but not the spring 5 shown in FIG. 2. The fishing line 8 is fastened to a standard lure or bait 7.

FIG. 2 illustrates a cross-sectional frontal view of the invention which allows the viewer to see the inner workings of the invention. A spherical hollow hole 11 runs the length of the tubular rod 4 from the top of the rod to the closing flap 9 at the bottom. This hollow tube 11 contains a spring 5 with a resting length of approximately 80%-90% of the tubular rod 4. The fishing line 8 runs through the center of both the tubular hole 11 and the spring 5. Resting on top of the spring 5 is a funnel 6 with a top portion that is wide and deep enough to hold a lure or bait 7, and a bottom portion with a hole that is narrow enough to allow the fishing line 8 to pass through it, but not the lure or bait 7. Near the top of the tubular hole 11 are two small notches 10 which protrude slightly from the inner wall of the tubular hole 11 that serve to prevent the funnel 6 from exiting the rod 4 but allowing the lure or bait 7 and fishing string 8 to exit the rod 4.

FIG. 2A is an exploded view of the upper portion described in detail in the previous paragraph.

FIG. 2B is an exploded view of the lower portion described in detail in the same paragraph as FIG. 2.

### DETAILED DESCRIPTION OF THE INVENTION

The fishing rod that the reel is connected to employs a standard handle and is attached to that handle in the same method as reels are today.

The handle is then connected to a lightweight cylinder that is conical in shape and is aligned directly over the hole on the reel where the string exits. This cylinder serves as the “rod” for the pole. The string does not run alongside the rod with the use of small rings to guide the string, but rather the string is located inside the cylinder and runs through the center of the tube, spring, and funnel.

The top of the cylinder is slightly rounded in shape and smooth in texture so that the hook cannot become caught upon leaving the water and entering the rod.

The inside of the cylinder contains a hollow center that runs the length of the cylinder. The bottom of the cylinder is then closed except for a small opening to allow the string to pass through.

Resting on the bottom of the cylinder, a spring is located whose width takes up the full diameter of the hollow center.

Resting on the spring is a funnel with a top whose width takes up the full diameter of the hollow center, and whose bottom is no more than a small hole to allow the string to pass through. This funnel serves to catch the lure or bait upon exiting the water and entering the cylinder.

The top of the cylinder may either have two small notches or become slightly narrower a few inches from the top of the cylinder, thereby not allowing the funnel, which is the exact diameter of the rest of the hollow cylinder, to pass through upon release. Both these configurations still allow the much narrower lure to pass through and out into the water.

The angler reels the lure or bait out of the water and into the tube. The lure is then caught in the funnel, but the string passes through the bottom of the funnel. As the angler reels in more string, the funnel containing the lure is engaged with the spring, which is continually compressed. When the spring is fully compressed, the caster stops reeling. With a push button reel, the string is not released until the caster pushes the release button, at which time the string is released, the pressure in the spring is released, sending the funnel containing the lure to the top of the cylinder until the funnel connects with the two small notches. The lure is then projected into the air.

1. A tubular fishing rod that contains a funnel and spring that compresses simply from the angler reeling in the string in the traditional manner and releasing by pressing the push-button;

2. A tubular fishing rod with a rounded top so as not to allow the lure to latch on while entering the tube and a slightly narrower top or small notches that do not allow the spring or funnel to exit the tube;

3. A funnel whose upper diameter is such that it matches the inside diameter of the tubular rod and lower portion which is much smaller and contains a hole that allows passage of fishing line but does not allow the fishing lure to pass through the bottom. This funnel does not exit the tubular rod, but rather serves to carry the lure to the end of the rod as the tension on the spring is released, thus allowing passage of the lure through the rod.

4. A reel mounted to a handle in the traditional fashion;

5. A handle connected to the tubular rod near the base;

6. A spring seat that contains a small hole for fishing line to pass through located at the bottom of the rod, but does not allow the spring to exit;

7. A spring contained inside the tubular rod that rests on a removable spring seat at the bottom of the tube that is connected to, or rests below, a funnel at the top of the tube;

8. A means by where compression of the spring is achieved simply by the angler reeling in the fishing string, allowing the lure to catch into the funnel, and allowing the funnel to compress the spring;

9. A fishing rod where said spring is released by pushing the button on the reel, thus releasing the tension on the string, allowing the spring to uncoil, pushing funnel to the top of the tube, stopping said funnel, and allowing the lure to exit.
